(19) United States
(12) Patent Application Publication
(10) Pub. No.: US 2008/0225307 A1
(43) Pub. Date: Sep. 18, 2008

(54) Image-Forming Device

(75) Inventors: Kentaro MURAYAMA, Kasugai-shi (JP); Ryohei NAKAGAWA, Nagoya-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/038,256

(22) Filed: Feb. 27, 2008

(30) Foreign Application Priority Data
Mar. 14, 2007 (JP) 2007-065093

(51) Int. Cl. G06F 15/00

(52) U.S. Cl. 358/1.4

(57) ABSTRACT

An image-forming device includes a pattern data generating unit, an image-forming unit and a detecting unit. The pattern data generating unit generates pattern data indicative of a pattern of a plurality of marks. The plurality of marks includes a first mark having a first color, a first light reflectance, a first width in a predetermined direction and a first dot density and a second mark having a second color, a second light reflectance, a second width in the predetermined direction and a second dot density. A difference between a target light reflectance and the first light reflectance is greater than a difference between a target light reflectance and the second light reflectance. At least one of the first mark width and the first dot density is smaller and lower than the second mark width and the second dot density. The image-forming unit forms the plurality of marks at positions on a target having the target light reflectance, based on the pattern data. The detecting unit detects the positions in the predetermined direction at which the plurality of marks is formed on the target, based on changes of light reflected from the target and the plurality of marks.

### CROSS REFERENCE TO RELATED APPLICATION

This application claims priority from Japanese Patent Application No. 2007-065093 filed Mar. 14, 2007. The entire content of each of these priority applications is incorporated herein by reference.

### TECHNICAL FIELD

The present invention relates to an image-forming device.

### BACKGROUND

Tandem image-forming devices are well known in the art. This type of image-forming device is typically provided with a photosensitive member for each of the colors yellow, magenta, cyan, and black, for example. The photosensitive members are juxtaposed along the circulating direction of a paper-conveying belt. Color images carried on the photosensitive members are thus transferred onto paper conveyed on the belt.

However, if the positions at which the color images are formed on the paper deviate from each other in this tandem image-forming device, the resulting color image is not registered properly. Hence, aligning the formation positions of the color images is vital.

To this end, Japanese unexamined patent application publication No. HEI-11-327249 discloses an image-forming device for detecting offset in the formation positions of the color images and for calibrating these positions. More specifically, this image-forming device forms a registration pattern configured of yellow, magenta, cyan, and black patterns on the conveying belt, each color pattern including a plurality of marks arranged along the conveying direction of the belt. The positions of marks constituting the color patterns formed on the belt vary according to positional offset of the corresponding colored images.

Therefore, the image-forming device sets one of the colors yellow, magenta, cyan, or black as a reference color, measures distances between marks in the pattern of the reference color and the patterns of the other colors based on detection signals outputted from photosensors detecting the positions of the marks, and determines whether these distances match predetermined values. If the distances do not match, then the image-forming device determines that the color images are out of registration and performs calibration to correct this registration error.

The photosensor described above includes a light-emitting element for irradiating light onto a portion of the belt positioned within a prescribed detection region, and a light-receiving element for receiving light reflected from the detection region, for example. The amount of light received by the light-receiving element changes as each of the colored marks on the moving belt passes sequentially through the detection region. Therefore, it is possible to detect positions of each colored mark based on the timing at which the amount of light received by the light-receiving element changes.

### SUMMARY

Here, the reflection characteristics of each mark differ according to the color of the mark and, consequently, the waveform of the light received by the light-receiving element also differs. By not giving any consideration to this data, Patent Reference 1 described above cannot always detect the position of each mark with accuracy because changes in the amount of reflected light for a certain colored mark interferes with changes in the amount of reflected light for other adjacent marks.

One method of overcoming this problem is to lengthen the distance between each colored mark, but this increases the overall length of the registration pattern and, hence, increases the time required for detecting the positions of the colored marks.

In view of the foregoing, it is an object of the present invention to provide an image-forming device capable of detecting data related to the position of each colored mark with accuracy, without lengthening the overall pattern.

In order to attain the above and other objects, the present invention provides an image-forming device including a pattern data generating unit, an image-forming unit and a detecting unit. The pattern data generating unit generates pattern data indicative of a pattern of a plurality of marks. The plurality of marks includes a first mark having a first color, a first light reflectance, a first width in a predetermined direction and a first dot density and a second mark having a second color, a second light reflectance, a second width in the predetermined direction and a second dot density. A difference between a target light reflectance and the first light reflectance is greater than a difference between a target light reflectance and the second light reflectance. At least one of the first mark width and the first dot density is smaller and lower than the second mark width and the second dot density. The image-forming unit forms the plurality of marks at positions on a target having the target light reflectance, based on the pattern data. The detecting unit detects the positions in the predetermined direction at which the plurality of marks is formed on the target, based on changes of light reflected from the target and the plurality of marks.

### BRIEF DESCRIPTION OF THE DRAWINGS

The particular features and advantages of the invention as well as other objects will become apparent from the following description taken in connection with the accompanying drawings, in which:

FIG. 1 is a cross-sectional view showing the overall structure of a printer according to a preferred embodiment of the present invention;

FIG. 2 is a block diagram showing the electrical structure of the printer;

FIG. 3 is a perspective view of a photosensor and conveying belt;

FIG. 4 is a circuit diagram of the photosensor;

FIG. 5 is an explanatory diagram showing the relationship between color patterns and the waveforms of light reception signals;

FIG. 6 is an explanatory diagram showing a registration pattern;

FIG. 7 is an explanatory diagram showing the relationship between color patterns and the waveforms of light reception signals;

FIG. 8 is a flowchart illustrating steps in a pre-process;

FIG. 9 is an explanatory diagram showing the relationship between auxiliary patterns and the waveforms of light reception signals; and

FIG. 10 is an explanatory diagram showing a registration pattern and the waveform of light reception signals based on this pattern in a second embodiment.

### DETAILED DESCRIPTION

### First Embodiment

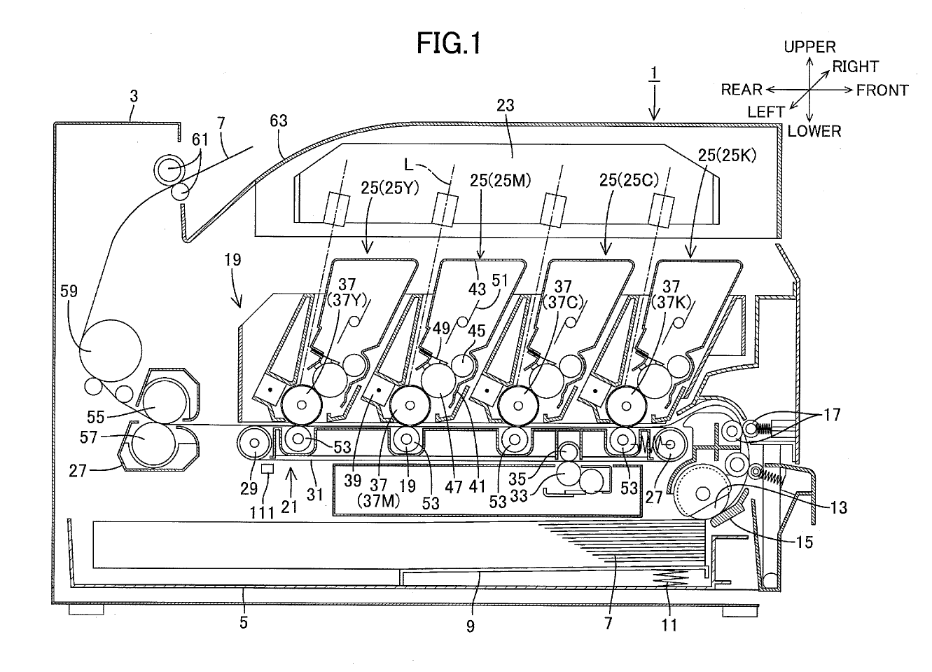

A preferred embodiment of the present invention will be described with reference to FIGS. 1 through 9.

### Overall Structure of the Printer

FIG. 1 is a side cross-sectional view showing the overall structure of a printer 1 according to the preferred embodiment. In the following description, the right side of the printer 1 (or right direction) in FIG. 1 will be referred to as the front side (or forward direction).

As shown in FIG. 1, the printer 1 is a direct transfer tandem-type color laser printer. The printer 1 includes a casing 3, and a paper tray 5 provided in the bottom of the casing 3 for holding a paper or other sheet-like recording medium 7 in a stacked state.

The printer 1 also includes a pressing plate 9 disposed in the paper tray 5 beneath the recording medium 7, a pickup roller 13 positioned above the front edge of the recording medium 7, a pair of registration rollers 17 disposed downstream of the pickup roller 13 with respect to a conveying direction, and a belt unit 21 disposed downstream of the registration rollers 17 in the conveying direction. The pressing plate 9 functions to press the recording medium 7 toward the pickup roller 13. The rotating pickup roller 13 picks up and conveys sheets of the recording medium 7 to the registration rollers 17. The registration rollers 17 correct skew in the sheets of recording medium 7 and convey the sheets onto the belt unit 21 at a prescribed timing.

The belt unit 21 includes a pair of support rollers 27 and 29, and an endless belt 31 looped around the support rollers 27 and 29. The driving rotation of the support roller 29 on the rear side, for example, moves the endless belt 31 circularly in the clockwise direction of FIG. 1 so that a sheet of recording medium 7 placed on top of the endless belt 31 is conveyed rearward.

A cleaning roller 33 is disposed on the underside of the belt unit 21 for removing toner (including a registration pattern 121″ or “marks 119” described later, paper dust, and the like deposited on the endless belt 31.

The printer 1 also includes an image-forming unit 19 disposed above the belt unit 21, a scanning unit 23, and a fixing unit 27. The image-forming unit 19 includes process units 25.

The scanning unit 23 is disposed above the image-forming unit 19 and includes a laser light-emitting element (not shown) controlled to turn on and off based on image data. The laser light-emitting elements are provided for each color and irradiate laser beams L that are scanned at a high speed over the surfaces of photosensitive drums 37 provided in the image-forming unit 19 for each color.

The image-forming unit 19 has four of the process units 25 corresponding to the colors black, cyan, magenta, and yellow. Each of the process units 25 has the same construction, excluding the color of toner and the like. In the following description, the letters K (black), C (cyan), M (magenta), and Y (yellow) are appended to part numbers when it is necessary to distinguish between each color, but are excluding when such distinction is unnecessary.

Each process unit 25 includes the photosensitive drum 37, a charger 39, and a developer cartridge 41.

Each developer cartridge 41 includes a toner-accommodating chamber 43, a supply roller 45, a developing roller 47, a thickness-regulating blade 49, and an agitator 51 disposed in the toner-accommodating chamber 43.

Toner is supplied onto the developing roller 47 by the rotation of the agitator 51 and supply roller 45. The toner carried on the surface of the developing roller 47 is regulated to a thin layer of uniform thickness by the thickness-regulating blade 49 as the toner passes between the thickness-regulating blade 49 and developing roller 47.

The charger 39 charges the surface of the photosensitive drum 37 with a uniform positive polarity. Subsequently, the scanning unit 23 irradiates a laser beam onto the surface of the photosensitive drum 37 to form an electrostatic latent image corresponding to a color image to be formed on the recording medium 7.

The toner carried on the developing roller 47 is subsequently supplied to the electrostatic latent image formed on the surface of the photosensitive drum 37. Accordingly, the electrostatic latent image on the photosensitive drum 37 is developed into a visible toner image for the corresponding color.

As a sheet of recording medium 7 conveyed on the endless belt 31 passes through a transfer position between the photosensitive drum 37 and a corresponding transfer roller 53, the toner image carried on the surface of the photosensitive drum 37 is transferred onto the recording medium 7 by a negative transfer bias applied to the transfer roller 53. In this way, toner images in each color are sequentially transferred onto the recording medium 7 as the recording medium 7 is conveyed to the fixing unit 27.

The fixing unit 27 includes a heating roller 55 and a pressure roller 57 for conveying the recording medium 7 while applying heat to the same. The heat applied to the recording medium 7 fixes the transferred toner images to the recording medium 7. After the images have been fixed in the fixing unit 27, the recording medium 7 is conveyed by a conveying roller 59 to discharge rollers 61. The discharge rollers 61 discharge the recording medium 7 onto a discharge tray 63 formed on top of the casing 3.

### Electrical Structure of the Printer

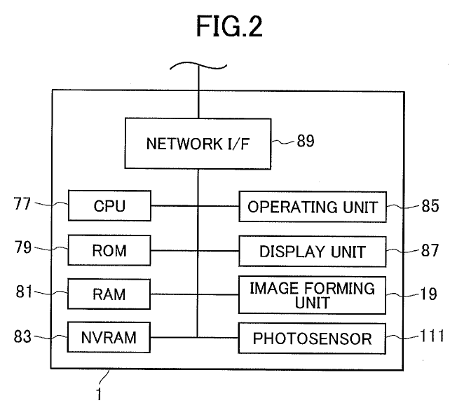

FIG. 2 is a block diagram showing the electrical structure of the printer 1. The printer 1 includes a CPU 77, a ROM 79, a RAM 81, an NVRAM (nonvolatile memory) 83, an operating unit 85, a display unit 87, the image-forming unit 19 described above, a network interface 89, and photosensors 111.

The ROM 79 stores various programs for controlling operations of the printer 1. The CPU 77 controls operations of the printer 1 based on the programs read from the ROM 79 while storing processing results in the RAM 81 and NVRAM 83.

The operating unit 85 includes a plurality of buttons that the user can operate to input various instructions, such as a command to initiate printing. The display unit 87 is configured of a liquid crystal display and lamps for displaying various setup menus, operating states, and the like. The network interface 89 connects the printer 1 to an external computer (not shown) via a communication line 71, enabling data communications between the printer 1 and the external computer.

### Position Calibrating Process

It is important to align the formation positions (transfer positions) of the color images in the tandem printer 1, because the color image will not be properly registered if the formation positions relative to the recording medium 7 deviate. Hence, a position calibrating process is performed to correct deviations in positions of the color images.

In the position calibrating process, the CPU 77 of the printer 1 reads data for a registration pattern 121A from the NVRAM 83, for example, and provides this data to the image-forming unit 19 as image data. The image-forming unit 19 forms the registration pattern 121A on the surface of the endless belt 31. The registration pattern 121A includes a plurality of marks 119 for each of the four colors, as will be described later, that are juxtaposed in the conveying direction of the endless belt 31 (front-to-rear direction of the printer 1).

IF the laser scanning positions are deviated from regular positions, the plurality of the marks 119 is not formed in positions ordered by the CPU 77. Therefore, the CPU 77 detects the positions of the marks 119 with the photosensors 111 described below, measures the amounts of deviation based on the detection results, and calibrates the laser scanning positions in order to cancel these deviations. Here, the laser scanning positions are positions in a subscanning direction in which the scanning unit 23 irradiates laser beams for each color onto the respective photosensitive drums 37. The laser scanning positions are modified by changing the timing at which the scanning unit 23 emits each laser beam.

1. Photosensors

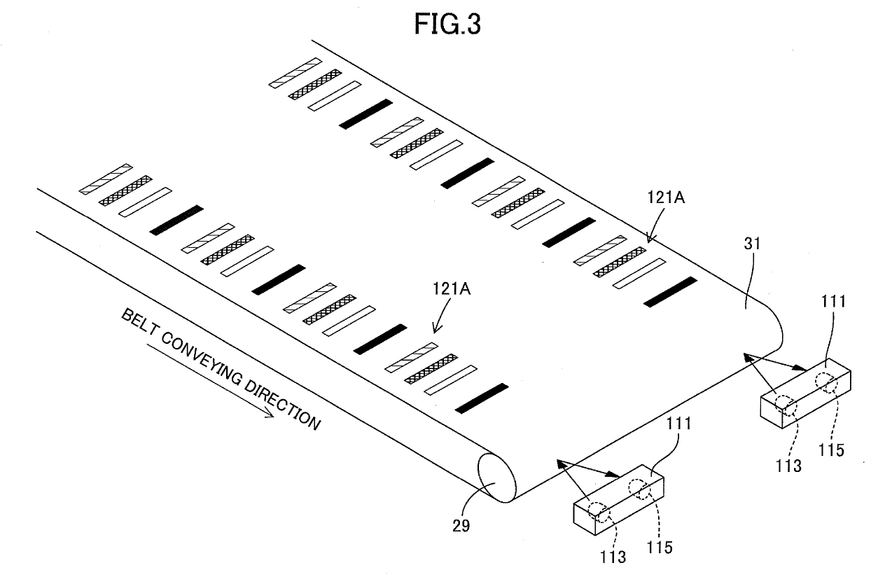

As shown in FIG. 3, one or a plurality (two in the preferred embodiment) of the photosensors 111 is provided on the rear side of the endless belt 31 and juxtaposed in the left-to-right direction. Each of the photosensors 111 is a reflection sensor provided with a light-emitting element (such as an LED), and a light-receiving element (such as a phototransistor) 115. The light-emitting element 113 irradiates light obliquely onto the surface of the endless belt 31, and the light-receiving element 115 receives the light reflected off the surface of the endless belt 31. The regions in which the light emitted from the light-emitting elements 113 forms spots on the endless belt 31 are the detection regions of the photosensors 111. The width of the marks 119 in the conveying direction of the endless belt 31 is narrower than the width of the detection region.

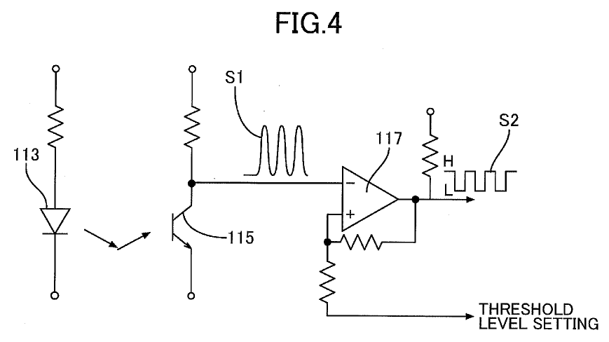

FIG. 4 is a circuit diagram of the photosensor 111. The light-receiving element 115 outputs a light reception signal S1 at a lower level the higher the level of received light, and a higher level the lower the level of received light. The S1 is inputted into a hysteresis comparator 117. The hysteresis comparator 117 compares the level of the light reception signal S1 to a threshold value (first and second threshold values TH1 and TH2 described later) and outputs a binary signal S2 having a level inverted based on the results of comparison.

2. Problems Associated with Differences in the Reflectance Characteristics of Achromatic and Chromatic Marks

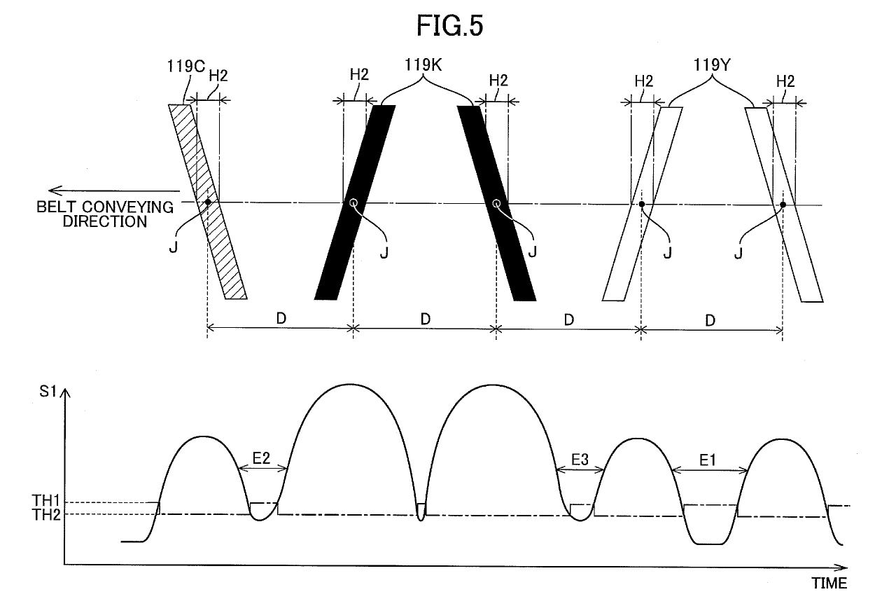

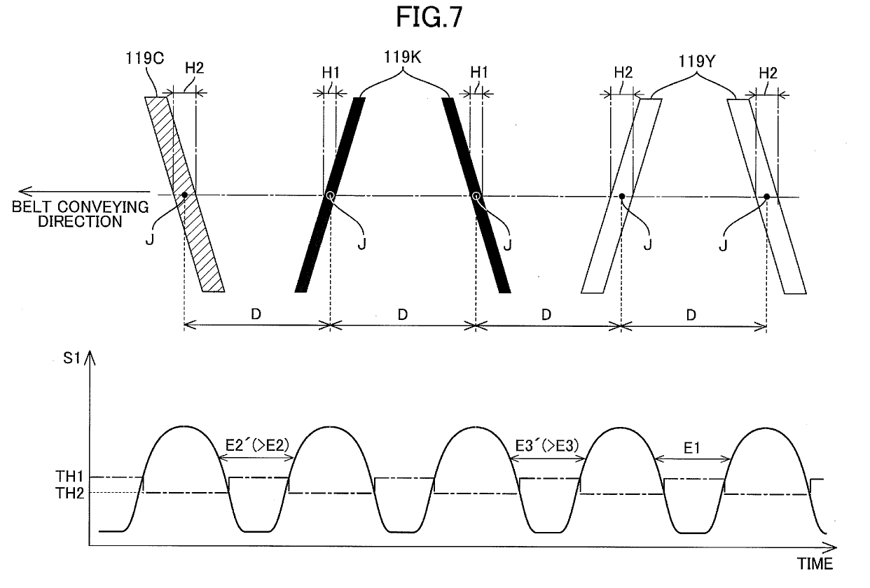

FIG. 5 shows the marks 119 of each color in the upper part of the drawing and the waveform of the light reception signal S1 when each mark 119 enters the detection region in the lower part of the drawing in the conventional technique. FIG. 7 shows the marks 119 of each color in the upper part of the drawing and the waveform of the light reception signal S1 when each mark 119 enters the detection region in the lower part of the drawing in the preferred embodiment. In FIGS. 5 and 7, the conveying direction of the endless belt 31 is toward the left.

The endless belt 31 in the preferred embodiment is formed of a material including polycarbonate, for example, and has a higher reflectance than toner of any of the four colors. Hence, the light reception signal S1 level is lowest when light irradiated from the light-emitting element 113 onto the background of the endless belt 31 (the surface of the endless belt 31 in which no mark is formed), as shown in FIGS. 5 and 7. On the other hand, when the light-emitting element 113 irradiates light onto the marks 119 formed on the endless belt 31, the light-receiving element 115 receives a lower level of light, resulting in a higher light reception signal S1 level.

Of the four colors used in the printer 1 of the preferred embodiment, cyan, magenta, and yellow are chromatic, while black is achromatic. Therefore, the reflectance of the black mark 119K is lower than the reflectances of the chromatic marks 119C, 119M, and 119Y. More specifically, the reflectance of the black mark 119K differs greatly from the reflectance of the endless belt 31, while the reflectances of the chromatic marks 119C, 119M, and 119Y differ slightly from the reflectance of the endless belt 31. A difference between the reflectance of the black mark 119K and any of the reflectances of the chromatic marks 119C, 119M, and 119Y is larger than a difference between the reflectances of any two of the chromatic marks 119C, 119M, and 119Y.

Therefore, under the condition that the marks are all the same shape, size and dot density (number of dots per unit area), the waveform of the light reception signal S1 produced by reflected light from the black mark 119K (hereinafter simplified to “the light reception signal S1 for the black mark 119K”) is broader along the time axis and has a higher peak than waveforms of the light reception signal S1 produced by the reflected light from the chromatic marks 119C, 119M, and 119Y (hereinafter simplified to “the light reception signal S1 for the chromatic marks 119C, 119M, and 119Y”), as shown in FIG. 5. Specifically, the light reception signal S1 for the black mark 119K depicts a waveform with a peak value and time width about 1.5 times those of the light reception signal S1 for the chromatic marks 119C, 119M, and 119Y.

FIG. 5 shows a conventional pattern in which the marks 119 of all colors are spaced at a uniform distance D. It is assumed that the distance between the black mark 119K and the marks positioned just before and just after the black mark 119K (the cyan mark 119C and the yellow mark 119Y in FIG. 5) is narrow, and the black mark 119K and the chromatic marks 119C, 119M, and 119Y are detected using common photosensors 111. In such a case, distances E2 and E3 between waveforms of the light reception signal S1 for the black mark 119K and the marks directly before and after the black mark 119K (the cyan mark 119C and yellow mark 119Y) are narrower than a distance E1 between waveforms of the light reception signal S1 for the yellow mark 119Y, as shown in FIG. 5. As a result, the waveforms of the light reception signal S1 can interfere with each other, making it impossible to detect each mark with accuracy. The CPU 77 calculates an intermediate position (intermediate timing) between the falling edge and rising edge of the binary signal S2, for example, and sets this intermediate position as the position of the respective mark 119.

Further, since the waveform of the light reception signal S1 differs between the black mark 119K and the chromatic marks 119C, 119M, and 119Y, if the marks are detected using common thresholds (a first threshold TH1 and second threshold TH2 described later), detection sensitivity may be undesirably irregular. To reduce the irregularity in detection sensitivity between the black mark 119K and the chromatic marks 119C, 119M, and 119Y, it is therefore necessary to provide separate thresholds for detecting the black mark 119K and for detecting the chromatic marks 119C, 119M, and 119Y.

3. Registration Pattern According to the Preferred Embodiment

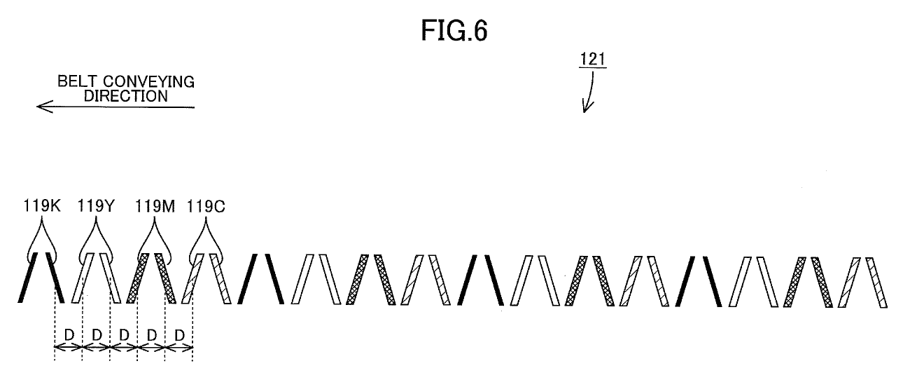

FIG. 6 shows the overall registration pattern 121 of the preferred embodiment. The registration pattern 121 is used to detect the amount of deviation in color registration in the subscanning direction (the conveying direction of the endless belt 31) and the main scanning direction (a direction orthogonal to the conveying direction of the endless belt 31). Specifically, the registration pattern 121 includes one or a plurality (four in the preferred embodiment) of sets of marks juxtaposed in the conveying direction of the endless belt 31. Each set of marks has a black mark 119K, a yellow mark 119Y, a magenta mark 119M, and a cyan mark 119C arranged in the order given. Each mark 119 has a pair of bar-shaped marks, and each mark of the pair is oriented at a prescribed angle to a straight line following the main scanning direction and is symmetrical to the other mark in the pair about the same straight line.

The CPU 77 detects the position of the pair of bar-shaped marks constituting each of the marks 119 based on the binary signal S2 outputted from the photosensors 111, and sets the position for each of the respective marks 119 to an intermediate position between the pair of bar-shaped marks. Next, the CPU 77 detects positional offset of the chromatic marks 119C, 119M, and 119Y relative to the black mark 119K in each set of marks. The CPU 77 calculates an average positional offset for the chromatic marks 119C, 119M, and 119Y in all sets of marks. The average offset for each colored mark is set as the amount of positional deviation in the subscanning direction for each color image relative to the black image. Next, the CPU 77 calibrates color registration in the subscanning direction by adjusting the timing at which the scanning unit 23 emits laser beams corresponding to each color based on the amount of positional offset in the subscanning direction.

Further, the CPU 77 detects the distance between both marks in each mark 119 and adjacent marks between neighboring marks 119. The CPU 77 calculates the average distance between each pair of adjacent bar-shaped marks in all marks 119 and sets the positional offset in the main scanning direction to the average value for each colored mark. Next, the CPU 77 calibrates color registration in the main scanning direction by adjusting the timing at which the scanning unit 23 emits laser beams for each color based on this positional offset in the main scanning direction.

In the preferred embodiment, as shown in FIG. 7, the black mark 119K of the registration pattern 121 has a mark width H1 in the subscanning direction (conveying direction of the endless belt 31) narrower than a mark width H2 of the chromatic marks 119C, 119M, and 119Y in the subscanning direction, so that the waveform of the light reception signal S1 for the black mark 119K has substantially the same peak value and signal width as the waveform of the s1 for the chromatic marks 119C, 119M, and 119Y. Hereinafter, the widths of all marks are collectively referred to as “mark width H”.

When the registration pattern 121A is formed as described above, distances E2′ and E3′ between neighboring waveforms of the light reception signal S1 for the black mark 119K and the respective preceding and succeeding marks (cyan mark 119C and yellow mark 119Y) becomes substantially the same as a distance E1 between neighboring waveforms of the light reception signal S1 for the yellow mark 119Y and magenta mark 119M. In other words, the distances E2′ and E3′ become broader than the distances E2 and E3 in FIG. 5. Thus, the waveform of the light reception signal S1 for the black mark 119K is prevented from interfering with the waveform of the light reception signal S1 for the preceding or succeeding marks cyan mark 119C and yellow mark 119Y. Therefore, the positions of the marks 119 can be detected accurately. Further, each mark 119 can be detected at a substantially uniform detecting accuracy, even if detecting the black mark 119K and the chromatic marks 119C, 119K, and 119Y using a common threshold.

Further, the distance between each mark in all marks 119 (the distance between center points J in the marks 119) is set uniformly to a prescribed distance D in the registration pattern 121. This prescribed distance D is the shortest distance sufficient for preventing the waveforms of the light reception signal S1 for neighboring chromatic marks 119C, 119M, and 119Y from substantively affecting mark detection accuracy, thereby shortening the overall length of the registration pattern 121 as much as possible.

4. First Distance Setting Process

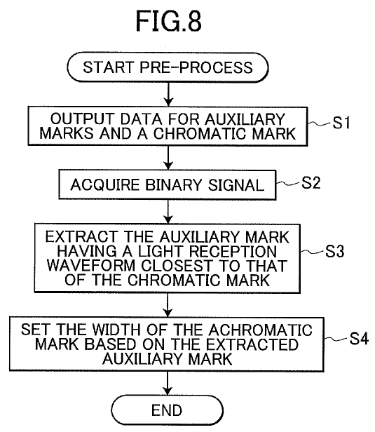

The CPU 77 may be configured to automatically execute a pre-process shown in FIG. 8 prior to performing color registration calibration when the timing for executing the color registration calibration process has arrived, for example. The color registration calibration process is executed, when, for example, a predetermined number of recording medium has been recorded, a predetermined time period has elapsed, and a user ordered to execute the color registration calibration.

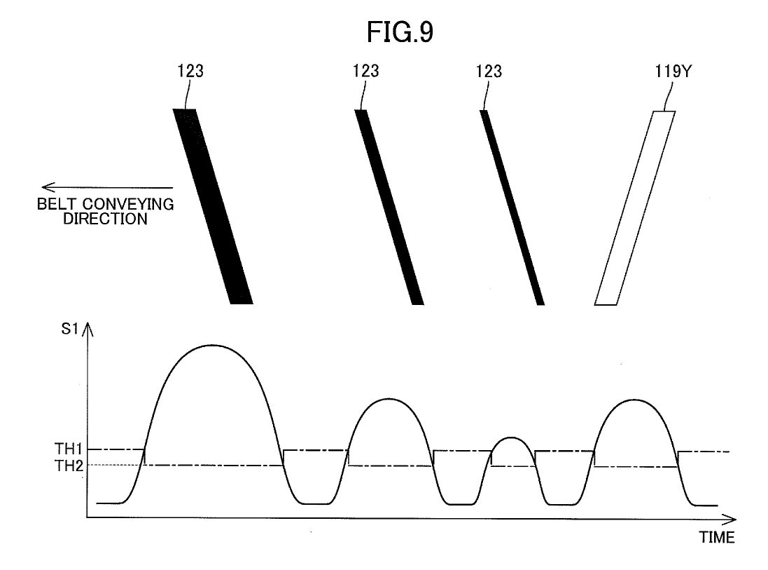

In S1 of this pre-process, the CPU 77 provides data for auxiliary marks 123 described later and data for at least one of the chromatic marks (the yellow mark, for example) to the image-forming unit 19. The auxiliary marks 123 are black marks like the black mark 119K, but comprise a set of marks having different mark widths H in the conveying direction of the endless belt 31. As shown in FIG. 9, the image-forming unit 19 forms three auxiliary marks 123 and the yellow mark 119Y, for example, on the endless belt 31, where the auxiliary marks 123 include an auxiliary mark having a large mark width H, an auxiliary mark having a medium mark width H, and an auxiliary mark having a small mark width H.

In S2 the CPU 77 acquires the binary signal S2 from the photosensors 111. Here, the waveforms of the light reception signal S1 for the auxiliary marks 123 have various peak values and signals widths corresponding to the different mark widths H. In S3 the CPU 77 extracts the auxiliary mark 123 having a signal width (difference in detection time between the rising edge and falling edge) closest to the waveform of the light reception signal S1 for the yellow mark 119Y, for example, from among the plurality of auxiliary marks 123. In the example of FIG. 9, the CPU 77 would extract the center auxiliary mark 123 (second from the left).

In S4 the CPU 77 sets the mark width H of the extracted auxiliary mark 123 as the mark width H of the black mark 119K in the registration pattern 121 to be used for the subsequent position calibrating process.

The light reception signal S1 waveform for the black mark 119K can vary according to changes in the printer 1 environment. Hence, it is preferable to modify the mark width H of the black mark 119K appropriately based on the environment through this pre-process.

### EFFECTS OF THE INVENTION

In the preferred embodiment, the reflectance of the endless belt 31 is greater than that of the black mark and the chromatic marks. The registration pattern 121 is configured so that the black mark 119K has a narrower mark width H in the conveying direction of the endless belt 31 than the other chromatic marks 119C, 119M, and 119Y. This configuration reduces interference between the reception light waveforms of the black mark 119K and the chromatic marks 119C, 119M, and 119Y. In contrast to the preferred embodiment, setting the mark width H of the black mark 119K greater than that of the chromatic marks would increase interference between the reception light waveforms for neighboring marks 119, thereby reducing mark detection accuracy.

Further, the marks 119 in the registration pattern 121 are spaced uniformly at a prescribed distance D. Reducing the length of the registration pattern reduces the time required for detection with the photosensors 111, thereby speeding up the position calibrating process.

The mark width H in the conveying direction of the endless belt 31 is identical for all of the chromatic marks 119C, 119M, and 119Y. Since the reflection characteristics of the chromatic marks 119C, 119M, and 119Y differ little according to the difference in color, the widths of these chromatic marks is set the same in order to simplify the process for detecting positions of the marks with the CPU 77.

### Second Embodiment

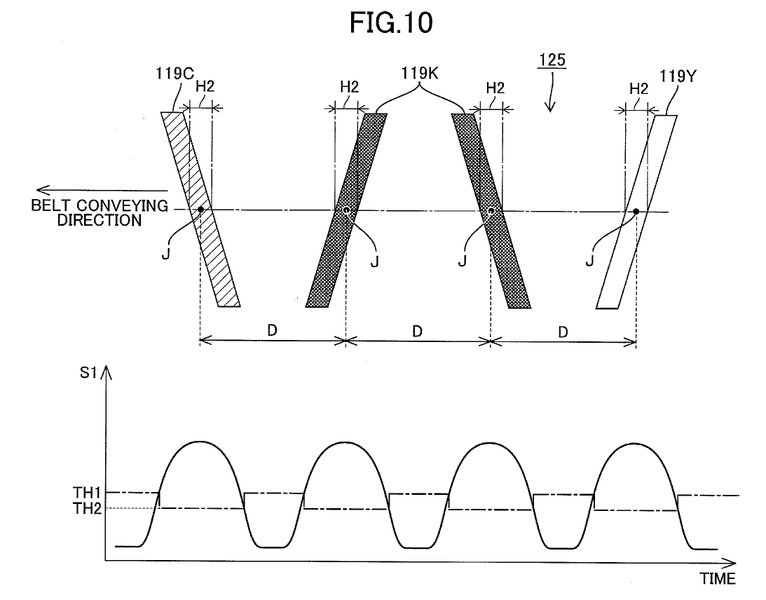

FIG. 10 is an explanatory diagram showing a registration pattern and the waveform of light reception signals based on this pattern in a second embodiment of the present invention. The second embodiment differs from the first embodiment in that the dot density of the black mark 119K is set lower than that of the chromatic marks, rather than reducing the mark width H of the black mark 119K. Other than this difference, the second embodiment is identical to the first embodiment and like parts and components are designated with the same reference numerals to avoid duplicating description. Only the above difference will be described below.

In a registration pattern 125 according to the second embodiment shown in FIG. 10, the dot density of the black mark 119K is set lower than that of the yellow mark 119Y, magenta mark 119M, and cyan mark 119C, simulating a lower density. As a result, the light reception signal S1 waveform for the black mark 119K has substantially the same peak value and signal width as those in the light reception signal S1 waveform for the chromatic marks 119C, 119M, and 119Y.

One method of varying the density of the marks 119 involves changing the intensity of the laser beams emitted from the laser light sources in the scanning unit 23 and varying the developing voltage applied to the developing rollers 47 in order to change the amount (thickness) of toner deposited on the photosensitive drums 37. However, it is difficult to adjust the developing voltage and the like with accuracy in order to form the marks 119 with the desired density in this method.

Therefore, the second embodiment employs a dither method for artificially modifying the density of the mark 119 by changing the number of dots per unit area (dot density) in bitmap data generated when the CPU 77 develops image data. Since the CPU 77 can adjust the density of marks when processing the image data in this method, it is possible to form marks 119 of a desired density more accurately than in the method of adjusting the developing voltages and the like.

When executing the pre-process described in the first embodiment, the CPU 77 may form auxiliary marks with different dot densities in the process of the second embodiment. Next, the CPU 77 can extract the auxiliary mark having a light reception signal S1 waveform closest to that of the chromatic mark and can set the dot density of the extracted auxiliary mark as the density of the black mark 119K in the registration pattern 125.

### VARIATIONS OF THE EMBODIMENTS

While the invention has been described in detail with reference to specific embodiments thereof, it would be apparent to those skilled in the art that many modifications and variations may be made therein without departing from the spirit of the invention, the scope of which is defined by the attached claims.

(1) In the preferred embodiments described above, only one of the mark width H and dot density for the achromatic (black) mark is varied from that of the chromatic marks. However, the image-forming device may be configured to modify both the mark width H and the dot density of the achromatic mark.

(2) While the reflectance of the endless belt 31 is set greater than that of the achromatic (black) mark and the chromatic marks, by setting the reflectance of the endless belt 31 smaller than that of the achromatic and chromatic marks, the light reception waveform of the light-receiving element for chromatic marks would be broader along the time axis than the light reception waveform of the light-receiving element for the achromatic mark. In this case, the registration pattern should be configured so that the distance between a chromatic mark and a preceding or succeeding chromatic mark is greater than the distance between adjacent achromatic marks. In this case, the registration pattern should be configured so that at least one of the mark width and dot density for the chromatic marks is set less than that of the achromatic mark.

(3) In the preferred embodiment described above, the CPU 77 performs calibration by adjusting the timing at which laser beams are emitted based on detected deviations in color registration. However, the CPU 77 may be configured to notify the user on the display unit 87 of the printer 1, for example, that the detected value exceeds the prescribed value, without performing calibration.

(4) In the preferred embodiment described above, the “target” on which patterns are formed is the endless belt 31 used for conveying the recording medium, but the target may be the recording medium 7 conveyed by the endless belt 31, such as a sheet of paper or transparency. Further, when the image-forming device employs an intermediate transfer system, the target may be the intermediate transfer belt functioning to directly carry developed images transferred from the image-carrying member.

(5) While the image-forming device in the preferred embodiment is a direct transfer-type color laser printer, the present invention may be applied to a laser printer with an intermediate transfer system or an inkjet printer. Further, the printer may employ two, three, or five or more colors.

(6) In the preferred embodiments described above, the mark width and/or dot density of the achromatic mark is set based on the light reception signal S1 waveforms for the auxiliary marks and the chromatic mark. However, this setting may be made solely based on the auxiliary marks. For example, the image-forming device may compare the light reception waveform of the auxiliary marks to those stored during the previous position calibrating process and set the mark width and/or dot density of the achromatic mark based on the difference.

What is claimed is:

1. An image-forming device comprising:
a pattern data generating unit configured to generate pattern data indicative of a pattern of a plurality of marks, the plurality of marks including a first mark having a first color, a first light reflectance, a first width in a predetermined direction and a first dot density and a second mark having a second color, a second light reflectance, a second width in the predetermined direction and a second dot density, a difference between a target light reflectance and the first light reflectance being greater than a difference between a target light reflectance and the second light reflectance, at least one of the first mark width and the first dot density being smaller and lower than the second mark width and the second dot density;
an image-forming unit configured to form the plurality of marks at positions on a target having the target light reflectance, based on the pattern data; and
a detecting unit configured to detect the positions in the predetermined direction at which the plurality of marks is formed on the target, based on changes of light reflected from the target and the plurality of marks.

2. The image-forming device according to claim 1, wherein the target light reflectance is greater than the first light reflectance and the second light reflectance.

3. The image-forming device according to claim 2, wherein the first color is an achromatic, and the second color is chromatic.

4. The image-forming device according to claim 1, wherein the detecting unit includes a signal generating unit configured to generate a light reception signal having a signal width for each mark, based on an amount of the light reflected from the target and the plurality of marks,
wherein the pattern data generating unit generates the pattern data such that the signal width for the first mark is same as the signal width for the second mark.

5. The image-forming device according to claim 1, wherein the pattern generating unit generates the pattern data such that centers between adjacent marks in the predetermined direction are spaced at uniform intervals.

6. The image-forming device according to claim 1, further comprising a calibrating unit configured to calibrate positions in which the image-forming unit forms images, based on the positions of the plurality of marks detected by the detecting unit.

7. The image-forming device according to claim 4, further comprising a modifying unit configured to modify at least one of the first width and the first dot density based on the light reception signal for the first mark.

8. The image-forming device according to claim 7, further comprising an auxiliary pattern data generating unit generating auxiliary pattern data indicative of a pattern of a plurality of auxiliary marks, each auxiliary mark having the first color and the first light reflectance, the plurality of auxiliary marks having a plurality of auxiliary width in the predetermined direction and a plurality of auxiliary dot densities different from one another in at least one of the auxiliary width and the auxiliary dot density,
wherein the modifying unit modifies at least one of the first width and the first dot density based on the light reception signal for the auxiliary marks.

9. The image-forming device according to claim 8, wherein the auxiliary pattern generating unit generates the auxiliary pattern data indicating the plurality of auxiliary marks and the second mark,
wherein the modifying unit modifies at least one of the first width and the first dot density based on the signal width for the auxiliary mark that is closest to the signal width of the second marks among the plurality of auxiliary marks.

10. The image-forming device according to claim 1, wherein the plurality of marks includes the plurality of second marks having chromatic colors different from one another and having a width in the predetermined direction and dot density equal to one another.
